(19) United States
(12) Patent Application Publication
(10) Pub. No.: US 2015/0367807 A1
(43) Pub. Date: Dec. 24, 2015

(54) ONE-PIECE WOVEN AIRBAG

(71) Applicants: Michael Becker, Schonau (DE); Andreas Enderlein, Bad Sackingen (DE)

(72) Inventors: Michael Becker, Schonau (DE); Andreas Enderlein, Bad Sackingen (DE)

(73) Assignee: Global Safety Textiles GmbH, Maulburg (DE)

(21) Appl. No.: 14/007,002

(22) PCT Filed: Mar. 16, 2012
(86) PCT No.: PCT/EP2012/001188

§ 371 Date: Dec. 5, 2013

(30) Foreign Application Priority Data
Apr. 15, 2011 (DE) 10 2011 017 207.6

(51) Int. Cl. B60R 21/235; D03D 1/02

(52) U.S. Cl. CPC B60R 21/235; D03D 1/02; B60R 2021/23547; B60R 2021/23509

(57) ABSTRACT

An OPW airbag having two opposing fabric layers made of warp and weft threads with at least one spacer that delimits the spacing of a chamber delimited by the fabric layers in the inflated state of the airbag. The spacer is formed by several of the warp and/or weft threads, so-called tethering threads, which, relative to the inflated state, extend from each layer in the direction of the opposing layer and are connected to warp and/or weft threads of the opposing layer. When warp tethering threads enter the opposing fabric layer, they each initially link with n weft threads and then float over at least n+1 weft threads in the interior of the chamber. When weft tethering threads enter the opposing fabric layer, they initially link with n warp threads and then float over at least n+1 warp threads in the interior of the chamber.

The present invention relates to a one-piece woven (OPW) airbag.

Known from EP 1 080 996 A2 is an OPW gas or airbag for motor vehicles, featuring two opposing woven fabric layers defining a gas-inflatable chamber, wherein the woven fabric layers consist of warp and weft threads with a tether connecting the woven fabric layers. The tether defines the spacing of the woven fabric layers from each other in the inflated state and is formed by several of the warp threads, which, relative to the inflated state, exit the area formed by the associated woven fabric layer and extend in the direction of the opposite woven fabric layer and are connected to weft threads of the opposite woven fabric layer. The tether as an integrated component of an OPW side curtain airbag has the task of tether and shortening the airbag when inflated. In this known airbag the floating threads (in this case warp threads) are interwoven in each case with the opposite woven fabric layer to a right-angled thread (in this case weft thread). The drawback in this arrangement is that the different stresses resulting from inflation cause microtears to materialize along the interweave, or, where coated, this becomes so bloated that microholes materialize, causing leakages in the airbag. The negative outcome of this is a significant reduction in the leakdown time of the airbag. Since in a crash and probably following roll-over phase—i.e. in the five seconds or so in which a side curtain airbag is required to remain inflated, before becoming deflated from loss of gas—such aforementioned leakages could prove to be fatal in such a situation.

In EP 1 080 996 A2, for example, the tethers have an X-shaped cross-section, also termed X-tether which when inflated, result in a 25% shortening of the area. In the tether zone a parabolic bulging occurs unlike the “restrained” full surface area of the bag wall or woven fabric layer. Deflation is accommodated by the floating tether threads. The tethers disclosed therein feature e.g. warp tether threads, all of which on entering each woven fabric layer are included juxtaposed in the weave simultaneously at one and the same first weft thread, on which they tug. This results in the extreme stress on this one weft thread prompting the aforementioned microtears in the neighbouring coating or in partial detachment of the coating from the woven fabric layer.

Following on from what is required by law as to the rules for the post-crash status of side curtain airbags—US Standard FMVSS 226 (Ejection Mitigation)—the performance of the cited prior art gas bag fails to be adequate for the reasons as stated.

This is why the object of the invention is based on proposing an OPW airbag which avoids, or at least greatly diminishes, the drawbacks known from prior art.

This object is firstly achieved by an OPW airbag as set forth in Claim 1 featuring two opposing woven fabric layers defining at least one gas-inflatable chamber, wherein the woven fabric layers consist of warp and weft threads with at least one tether that is connected to the woven fabric layers and defines the spacing of the woven fabric layers from one another in the inflated state, wherein said tether is formed by several of the warp and/or weft threads, termed tether threads, which, relative to the inflated state, exit the area formed by the associated woven fabric layer and extend in the direction of the opposite woven fabric layer and are connected to warp and/or weft threads of the opposite woven fabric layer, characterized in that when entering the opposite woven fabric layer, said warp tether threads each initially weave with n weft threads in forming a loop and then float over at least n+1 weft threads in the interior of the chamber. Now, to advantage, the stresses materializing on inflation of the airbag in accordance with the invention are reduced by an improved interweaving of the tether threads, or are distributed to several locations statistically, in thus preventing tearings in the fabric on being floated such as in any coating or lamination provided. In addition to this, the requirements as per FMVSS 226 are now satisfied by the structure in accordance with the invention, as also applies to asymmetrical airbags having a higher longitudinal stiffness.

In a further advantageous embodiment of the invention said warp tether threads subsequently float over at least n+1 weft threads in the exterior of the chamber, before becoming woven in the opposite woven fabric layer in a chamber weave, particularly in a L 1/1 plain weave. This now boosts to advantage the elasticity of the structure and the resistance of the airbag to tearing in the interweaving region of the tether in the woven fabric layer.

In another advantageous embodiment of the invention sequencing a plurality of tethers results in a systematic alternation of floating warp tether threads in that said floating warp tether threads in a first tether are not floated in the next tether in also not functioning there as a tether. This now achieves to advantage a more even distribution of the stress on the tether threads of a single tether to a plurality of tether threads. This in turn now attains an even and creaseless working-in of all threads in the tether direction (longitudinally) in thus avoiding loose longitudinal (warp) threads due to the systematic alternation of floating tether threads in a sequential arrangement thereof. The shear forces can also be accommodated at the interweave of tether threads in the opposite woven fabric layer by three transverse threads, now rendering the whole tether structure more stable and elastic, resulting in added functional reliability. This in turn adds to the useful life whilst enhancing the stress-relief.

In yet another advantageous embodiment of the invention in the tethered zone the ratio of threads, on the one hand, remaining between interwoven threads and, on the other hand, floating threads in the corresponding woven fabric layer is 6:1, a ratio that has proven to be an optimum. A higher thread ratio of, e.g. 7:1 or higher would increase the differences in stress. To advantage every fourth thread floats over the tether length.

The object is also achieved by an OPW airbag as set forth in Claim 5, the details of which are the same as cited above except that the tether threads are now weft threads interwoven with warp threads, whereas in Claim 1 et seq warp tether threads are interwoven with weft threads.

For a better understanding of the invention in showing how it is designed it will now be briefly described by way of example embodiments with reference to the drawing, wherein airbag, OPW airbag, curtain bag are understood to involve one and the same, namely an OPW airbag. In the drawing

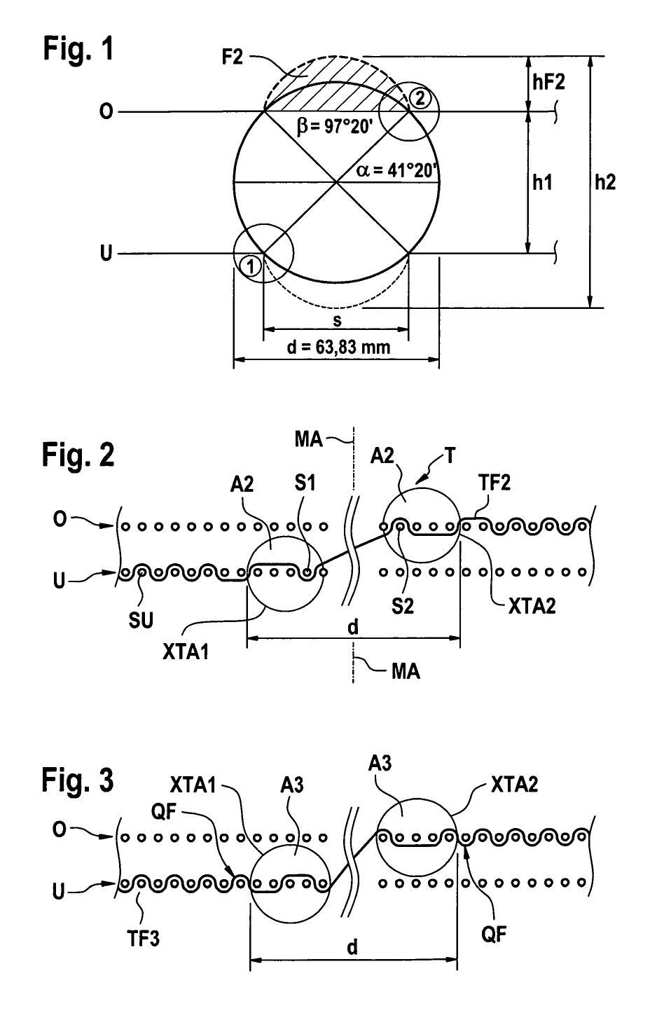

FIG. 1 illustrates the basic structure of a prior art X-tether.

FIG. 2 illustrates greatly simplified diagrammatically a portion in section of an airbag in accordance with the invention, showing how the floating tether threads are looped in the region of the bulge when interweaving the opposite woven fabric layer in each case.

FIG. 3 illustrates like FIG. 2 diagrammatically interweaving each floating tether thread in turn.

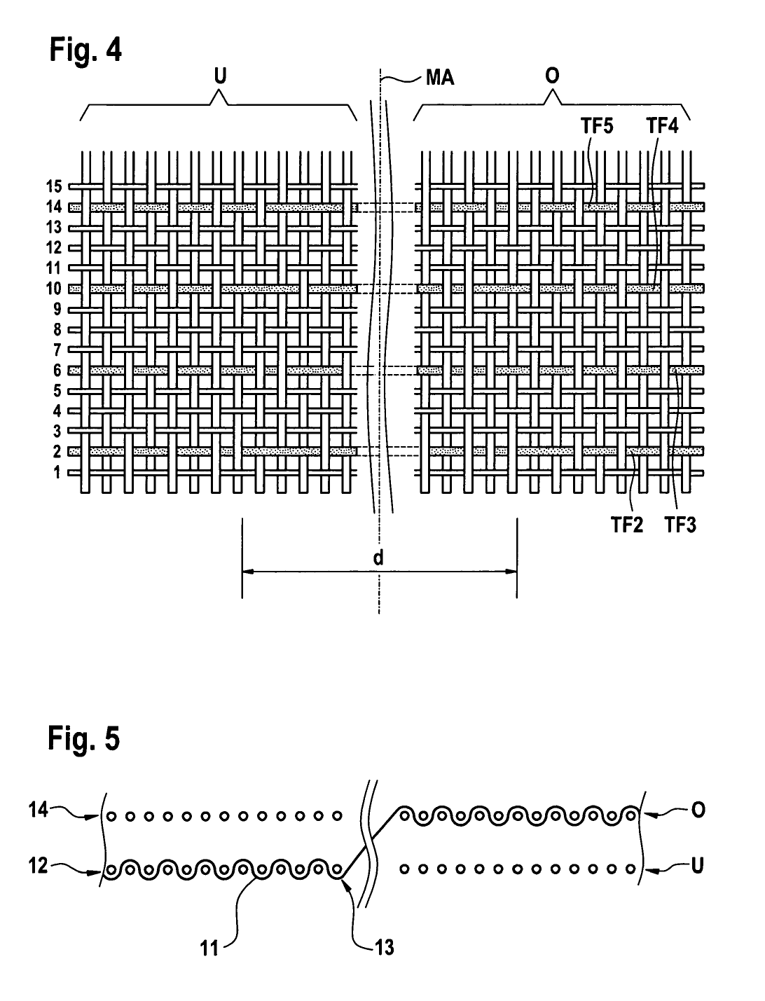

FIG. 4 illustrates in a top-down view the weave variants as shown in FIGS. 3 and 4.

FIG. 5 illustrates greatly simplified diagrammatically a portion of a prior art airbag.

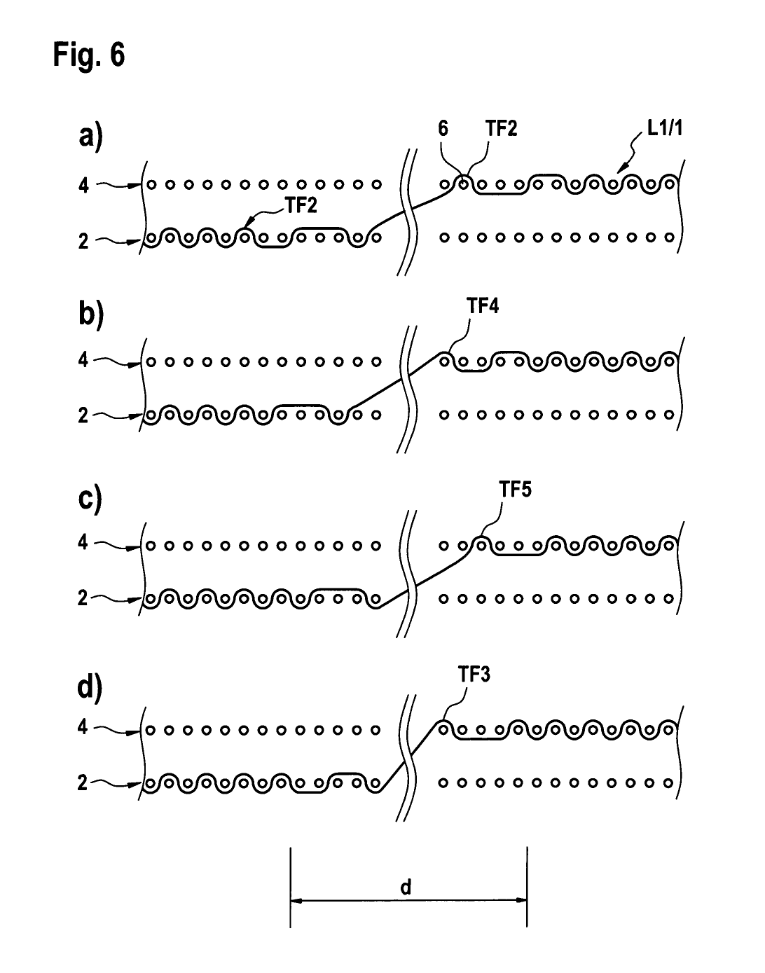

FIGS. 6a to 6d illustrate a further example embodiment of the invention like FIGS. 2 and 3 diagrammatically interweaving each floating tether thread in turn.

Referring now to FIG. 1 there is illustrated the basic structure of an X-tether inflated at an angle of 41° 20′ and shortened from d to s by 25%.

100×cos α≈75%

h1=d×sin α(thickness of airbag between its walls)

s=d×cos α(shortened tether length)

The curves correlating length and shortening of the tether come together at an angle of 45°. This theoretical derivation of the standing angle of the tether would correspond to a shortening of 30%. But in actual inflation testing it was discovered that the inflation angle α=41° 20′, i.e. the shortening amounts to 25% to 75% of the length as compared to when laid out flat

cos α=0.75088×100=75%

The pressurization in N/cm2×0.70711 (sin 45°) gives—like the calculation of the sigma value after measuring the LD-dyn—the traction load in the warp and weft direction in N/cm.

The traction load on the thread as calculated by the formula

$$\frac{N / cm \times 100}{Fd / cm} = cN / Fd$$

is uniform in the direction transversely to the direction of the tether (weft).

In the direction of the tether (warp) there is a total of three different traction loadings on the thread:
in the full surface area (with the full number of threads/cm)
in the thinned surface area of the bulge
corresponding to the ratio 3:1, 1.33 times the traction loading, and
for the tether threads, because of the lesser thread density and the tether function and the shortening in length as given by the formulated

$$\frac{N / cm \times 100 \times 2}{\frac{Fd / cm}{4}} = cn / tether thread$$

an 8 times traction loading acting as a shear force on the receiving threads of the opposite woven fabric layer.

Traction loading of the tether threads is to be taken into account structurally (denier, modulus, thread ratio) such that 8 times the traction loading occurs in Hooke's range at <1% strain.

The thickness of the curtain bag when inflated involves:
the thickness of the two-layer body of the bag (h1 as per FIG. 1) and
the height extending above the latter of the parabolic bulges in the tether zone (hF2 or h2 as per FIG. 1)

By way of the example as shown in FIG. 1 calculating the height of the bag is as follows:

h1=d×sin α

=63.83×0.66044

h1=42.17 mm

=d×cos α

=63.83×0.75088

=47.93 mm

Inflating the airbag results in the tether threads being shortened from d to s. The length of the arc d of a circular section area under an angle β [symbol] would mean a larger radius or a longer chord. Accordingly, the area F1 (circular section) is to be equalized with the area F2 (parabolic section).

Referring now to FIG. 2 there is illustrated the loopings A2 of the floating tether thread TF2 in the region of the bulge on interweaving in the corresponding opposite woven fabric layer. Each circle identifies the X-tether weave XTA1 and XTA2 whilst d indicates the width of the tether. The warp thread TF2 exits the lower woven fabric layer around the weft threads SU, indicated as circles, of the lower woven fabric layer up to the location XTA1 to then lie floating under two weft threads SU—this is where the tether zone begins—to then float over three weft threads SU. Then, again a single weft thread S1 is interwoven, after which the tether thread TF2 exits the lower woven fabric layer U to run upwards to the upper woven fabric layer O where it produces the interweavings in the upper woven fabric layer punctiform symmetrical to the center axis MA of the tether T. When the airbag is inflated on deployment the tether thread TF2 is subjected to traction which then subjects the weft threads S1 and S2 to traction in the tether zone, causing the weft threads S1 and S2 to be tractioned in the looping point to the middle of the bag. Because, as viewed from the gas-inflatable chamber, each tether thread floats over a further three weft threads according to the invention, the traction has a mild effect on the planes of the woven fabric.

Referring now to FIG. 3 there is illustrated a further situation similar to that as shown in FIG. 2 depicting the loopings A3 of the floating tether thread TF3, except that in this case the tether thread, as viewed from the center axis MA (see also FIGS. 2 and 4) of the tether T, is looped on the first weft thread. In addition to the loopings in the region of the parabolic shaped bulge it is evident how the first two transverse (weft) threads QF accommodate the transverse traction of the tether threads in the full surface area of the opposite woven fabric layer.

Referring now to FIG. 4 there is illustrated variants of how the tether threads are looped or interwoven in the opposite woven fabric layer as shown in FIGS. 2 and 3 (TF2 and TF3) as well as in the top-down view of FIG. 6 (TF2 to TF5). In FIG. 4 on the left the warp threads are numbered 1 to 15 of the lower woven fabric from the bottom upwards in a column. Disposed between floating tether threads are the “regular” warp threads interwoven in each woven fabric layer in the thread ratio 4/1.

Illustrated in this example are the floating tether threads from the lower to the upper woven fabric layers in an angular direction. It is understood that corresponding to the basic structure of the tether as shown in FIG. 1 this applies the same in the opposite angular direction.

Referring now to FIG. 5 there is illustrated greatly simplified diagrammatically a section through a portion of a prior art airbag in which warp threads 11 are interwoven in the lower woven fabric layer 12 in a L 1/1 weave in alternating at a freely definable point 3 into the upper woven fabric layer 14 wherein—as in the lower woven fabric layer 12—are interwoven in a L 1/1 weave. In doing so, all of the floating warp threads interweave at the same weft thread. This is what can cause the trouble due to increased stresses on inflation, prompting microtears along the interweave line capable of resulting in the bag failing to deploy properly.

Referring now to FIGS. 6a to 6d there is illustrated in section various examples of structuring the loopings as per TF2 to TF5 in the bulging zone of the X-tether as well as how the tether threads are interwoven in the corresponding opposite woven fabric layer. This interweaving in a single layer is usually done in a plain weave, although it could just as well be done in a rep or basket weave or in a combination of all three as cited. It is, however, to be noted that not all of the floating warp threads loop the same weft thread (FIGS. 6a, 6b and 6c) they possibly instead being distributed over at least two weft threads with the advantage that the load on deployment can be distributed over several weft threads. The special advantage in this is that the weft thread is simply stretched in enabling it to release the distance in the zones in which it floats over three or two weft threads. It is this addition in length that reduces the momentary force stressing the weft threads, resulting in the looping location of the tether being less stressed.

It is understood that the above description relates to the invention in which the tether threads are each warp threads interwoven with weft threads. But as set forth in Claims 5 to 8 the invention also involves an OPW airbag in which the tether threads enter the woven fabric layers as weft threads where they interweave with warp threads. Employing the one or other approach depends on how the OPW airbag is located on the weaving machine in the web of the fabric. In all other aspects the details remain the same, i.e. the thread systems in the tether zone as set forth in Claims 5 to 8 are simply the inverse of those as set forth in Claims 1 to 4.

What is claimed is:

1. A one-piece woven (OPW) airbag for motor vehicles, featuring two opposing woven fabric layers defining at least one gas-inflatable chamber, wherein the woven fabric layers consist of warp and weft threads with at least one tether that is connected to the woven fabric layers and defines the spacing of the woven fabric layers from one another in the inflated state, wherein said tether is formed by several of the warp and/or weft threads, so-called tether threads, which, relative to the inflated state, exit the area formed by the associated woven fabric layer and extend in the direction of the opposite woven fabric layer and are connected to warp and/or weft threads of the opposite woven fabric layer, wherein when entering the opposite woven fabric layer, said warp tether threads each initially weave with n weft threads and then float over at least n+1 weft threads in the interior of the chamber.

2. The one-piece woven airbag as set forth in claim 1, wherein said warp tether threads subsequently float over at least n+1 weft threads in the exterior of the chamber, before becoming woven in the opposite woven fabric layer in a chamber weave, particularly in a L 1/1 plain weave.

3. The one-piece woven airbag as set forth in claim 2, wherein sequencing a plurality of tethers results in a systematic alternation of floating warp tether threads wherein said floating warp tether threads in a first tether are not floated in the next tether.

4. The one-piece woven airbag as set forth in claim 1, wherein in the tethered zone the ratio of threads, on the one hand, remaining between interwoven threads and, on the other hand, floating threads in the corresponding woven fabric layer is ≦6:1.

5. A one-piece woven (OPW) airbag for motor vehicles, featuring two opposing woven fabric layers defining at least one gas-inflatable chamber, wherein the woven fabric layers consist of warp and weft threads with at least one tether that is connected to the woven fabric layers and defines the spacing of the woven fabric layers from one another in the inflated state, wherein said tether is formed by several of the warp and/or weft threads, so-called tether threads, which, relative to the inflated state, exit the area formed by the associated woven fabric layer and extend in the direction of the opposite woven fabric layer and are connected to warp and/or weft threads of the opposite woven fabric layer, wherein when entering the opposite woven fabric layer, said weft tether threads each initially weave with n warp threads and then float over at least n+1 warp threads in the interior of the chamber.

6. The one-piece woven airbag as set forth in claim 5, wherein said weft tether threads subsequently float over at least n+1 warp threads in the exterior of the chamber, before becoming woven in the opposite woven fabric layer in a chamber weave, particularly in a L 1/1 plain weave.

7. The one-piece woven airbag as set forth in claim 6, wherein sequencing a plurality of tethers results in a systematic alternation of floating weft tether threads wherein said floating weft tether threads in a first tether are not floated in the next tether.

8. The one-piece woven airbag as set forth in claim 5, wherein in the tethered zone the ratio of threads, on the one hand, remaining between interwoven threads and, on the other hand, floating threads in the corresponding woven fabric layer is ≦6:1.
